(19) United States
(12) Patent Application Publication
(10) Pub. No.: US 2014/0047782 A1
(43) Pub. Date: Feb. 20, 2014

(54) GROUND ANCHOR FOR OUTDOOR IMPLEMENTS

(71) Applicant: Ralph Fahler, Gaylord, MI (US)

(72) Inventor: Ralph Fahler, Gaylord, MI (US)

(21) Appl. No.: 13/586,390

(22) Filed: Aug. 15, 2012

(51) Int. Cl. E02D 5/80; B65H 75/44; E06C 7/42

(52) U.S. Cl. 52/164; 182/111; 242/406

(57) ABSTRACT

A ground anchor positively anchors an outdoor implement in place to the ground. The ground anchor comprises an arm defining opposed first and second ends of the arm. The first end is pivotably and directly connected to the implement such that the arm is pivotable with respect to the implement. A spike defines opposed first and second ends of the spike and is arcuate such that the spike is operatively concave with respect to the arm. The first end of the spike is pivotably connected to the second end of the arm such that the spike is rotatable about the second end of the arm. The second end of the spike is adapted to be manually imbedded into the ground at a right or an acute angle with respect to the arm to, thereby, positively anchor the implement in place to the ground with pretension.

### BACKGROUND OF INVENTION

1. Field of Invention

The invention relates to, generally, an anchor and, more particularly, an anchor for positively anchoring an outdoor implement in place to ground.

2. Description of Related Art

There are certain dangers or inconveniences associated with use of an implement outdoors on non-solid surfaces—such as grass, snow, or soil (hereinafter referred to merely as “ground”). An example of such an implement is a ladder—e.g., an extension ladder, a step ladder, or a straight ladder. More specifically, level and/or non-slippery ground is not always present upon which to position the ladder, and often a user of the ladder can only try his/her best to stabilize the ladder before he/she climbs it. However, even when the ladder is placed on level and non-slippery ground and against a solid structure (such as a house), the ladder can become more and more unstable as the user climbs it. A bottom portion of the ladder can easily “kick-out,” slip, bounce, slide, or otherwise move with respect to the structure (away from or alongside) and/or ground, and, in turn, fall. Of course, the falling ladder cannot only injure the user climbing the ladder and other people located in the vicinity of the fall, but also damage the ladder and other property similarly located. Such injury and/or damage can be prevented if the ladder is properly anchored in place to the ground before the ladder is climbed.

Another example of such an implement is a hose-reel assembly. More specifically, such an assembly can be large and aesthetically displeasing in the context of its immediate surroundings—for example, a yard and structure (e.g., house, garage, or shed) that sits upon the yard. As such, the assembly is often strategically placed on ground of the yard such that the assembly is situated adjacent the structure, yet generally hidden from view (since the assembly can detract from aesthetics of the yard and/or exterior of the structure). But, the assembly is still located sufficiently close to a work site such that a corresponding hose of the assembly can be employed at the work site without displacement of the assembly. Alternatively, wherever the assembly may be located, when the work site is located beyond reach of the hose (when the hose is completely unreeled with respect to the assembly), the assembly is relocated and strategically placed on ground of the yard such that the assembly is situated in a substantially central spot of an area of the work site (when the hose is completely reeled with respect to the assembly). In this way, as the hose is needed farther away from this spot, the hose can be merely correspondingly unreeled from the assembly without displacement of the assembly.

However, because the assembly is generally relatively lightweight and disposed on wheels, when a user of the assembly unreels the hose therefrom, the assembly often tends to move in the direction in which the hose is being pulled from the assembly (due generally to a high coefficient of static friction between the hose and a spool of the assembly about which the hose is reeled). And, the more hose that is unreeled from the assembly, the lighter the assembly becomes such that the assembly can become more and more unstable relative to the ground as the user unreels the hose. As a result, when the hose is being unreeled from the assembly, the assembly can undesirably move relative to the ground (in fact, even more than the hose is unreeling relative to the assembly). Such movement can be prevented if the assembly is properly anchored in place to the ground before the hose is unreeled from the assembly.

Devices are known for anchoring a ladder and other kinds of implement in place to ground. As an example, such a known device, for reasons of safety, positively anchors to the ground a bottom portion of a ladder that is supported by the ground and a side of a structure to prevent displacement of the ladder. However, this known device: 1) does not effectively prevent the displacement of the ladder away from the structure (“fore and aft” restraint) as well as effectively stabilize the ladder from slipping side to side (“lateral” restraint) and coming oil the ground (“upward” restraint); 2) cannot be provided on one rail or more rails of the ladder without the device interfering with any rung of the ladder; 3) cannot be provided on a bottom rung of the ladder without the device interfering with any rail of the ladder; 4) cannot be easily and quickly manually embedded far enough into the ground to provide adequate support to the ladder during use thereof on the ground when it is uneven or unstable while still allowing easy and quick manual removal of the device from the ground; 5) interferes with or causes damage to the ladder or causes damage to the ground while the device is being embedded into or removed from the ground; 6) requires a user of the device to search for and use supplemental tools for him/her to insert/remove the device into/from the ground; 7) is structurally complicated; and/or 8) is expensive to manufacture.

As another example, such a known device, for reasons of convenience, positively anchors to the ground a bottom portion of another kind of implement that is supported by the ground to prevent displacement of the implement. However, this known device suffers from similar disadvantages from which the known device described immediately above suffers in connection with the ladder.

Accordingly, there is a need in the related art for an anchor that positively anchors an outdoor implement in place to ground. More specifically, there is a need in the related art for such an anchor that, for reasons of safety, positively anchors to the ground a bottom portion of a ladder that is supported by the ground and a side of a structure to prevent displacement of the ladder. There is a need in the related art for such an anchor that also effectively prevents the displacement of the ladder away from the structure as well as effectively stabilizes the ladder from slipping side to side and coming off the ground. There is a need in the related art for such an anchor that also can be provided on one rail or more rails of the ladder without the anchor interfering with any rung of the ladder. There is a need in the related art for such an anchor that can be provided on also a bottom rung of the ladder without the anchor interfering with any rail of the ladder. There is a need in the related art for such an anchor that can be also easily and quickly manually embedded far enough into the ground to provide adequate support to the ladder during use thereof on the ground when it is uneven or unstable while still allowing easy and quick manual removal of the anchor from the ground. There is a need in the related art for such an anchor that also does not interfere with or cause damage to the ladder or cause damage to the ground while the anchor is being embedded into or removed from the ground. There is a need in the related art for such an anchor that does not also require a user thereof to search for and use supplemental tools for him/her to insert/remove the anchor into/from the ground. There is a need in the related art for such an anchor that also is not structurally complicated. There is a need in the related art for such an anchor that is also not expensive to manufacture. There is a need in the related art for such an anchor that also, for reasons of convenience, positively anchors to the ground a bottom portion of another type of implement that is supported by the ground to prevent displacement of the implement and benefits from advantages similar to those described immediately above in connection with the ladder.

### SUMMARY OF INVENTION

The invention overcomes the disadvantages in the related art in a first embodiment of an anchor for positively anchoring an outdoor implement in place to ground. The ground anchor comprises an arm defining opposed first and second ends of the arm. The first end is pivotably connected to the implement such that the arm is pivotable with respect to the implement. A spike defines opposed first and second ends of the spike and is arcuate such that the spike is operatively concave with respect to the arm. The first end of the spike is pivotably connected to the second end of the arm such that the spike is rotatable about the second end of the arm. The second end of the spike is adapted to be manually imbedded into the ground at substantially a right or an acute angle with respect to the arm to, thereby, positively anchor the implement in place to the ground with pretension.

The invention overcomes the disadvantages in the related art also in a second embodiment of an anchor for positively anchoring an outdoor implement in place to ground. The ground anchor comprises a brace attached to the implement and a support defining opposed first and second ends of the support. An arm extends between the brace and support and defines opposed first and second ends of the arm. The first end of the arm is pivotably connected to the brace and, thus, implement such that the arm is rotatable about the brace, and the second end of the arm is attached to the support. Each of at least a pair of opposed spikes defines opposed first and second ends of the spike and is arcuate such that the spike is operatively concave with respect to the arm. The first ends of the corresponding spikes are attached respectively to the first and second ends of the support such that the spikes are rotatable about the brace via the arm. The second ends of the corresponding spikes are adapted to be manually imbedded into the ground at substantially a right or an acute angle with respect to the arm to, thereby, positively anchor the implement in place to the ground with pretension.

The invention overcomes the disadvantages in the related art also in a third embodiment of an anchor for positively anchoring an outdoor implement in place to ground. The ground anchor comprises a brace attached to the implement and a support defining opposed first and second ends of the support and attached to the brace. Each of at least a pair of arms defines opposed first and second ends of the arm. The first ends of the corresponding arms are pivotably connected respectively to the first and second ends of the support and, thus, implement such that the arms are rotatable about the support and, thereby, pivotable with respect to the implement. Each of at least a pair of opposed spikes defines opposed first and second ends of the spike and is arcuate such that the spike is operatively concave with respect to the corresponding arm. The first ends of the corresponding spikes are pivotably connected respectively to the second ends of the corresponding arms such that the spikes are respectively rotatable about the second ends of the arms and support via the arm. The second ends of the corresponding spikes are adapted to be manually imbedded into the ground at substantially a right or an acute angle with respect to the corresponding arms to, thereby, positively anchor the implement in place to the ground with pretension.

One advantage of the anchor for positively anchoring an outdoor implement in place to ground of the invention is that it, for reasons of safety, positively anchors to the ground a bottom portion of a ladder that is supported by the ground and a side of a structure to prevent displacement of the ladder.

Another advantage of the ground anchor of the invention is that it effectively prevents the displacement of the ladder away from the structure as well as effectively stabilizes the ladder from slipping side to side and coming off the ground.

Another advantage of the ground anchor of the invention is that it can be provided on one rail or more rails of the ladder without the ground anchor interfering with any rung of the ladder.

Another advantage of the ground anchor of the invention is that it can be provided on a bottom rung of the ladder without the ground anchor interfering with any rail of the ladder.

Another advantage of the ground anchor of the invention is that it can be easily and quickly manually embedded far enough into the ground to provide adequate support to the ladder during use thereof on the ground when it is uneven or unstable while still allowing easy and quick manual removal of the ground anchor from the ground.

Another advantage of the ground anchor of the invention is that it does not interfere with or cause damage to the ladder or cause damage to the ground while the ground anchor is being embedded into or removed from the ground.

Another advantage of the ground anchor of the invention is that it does not require a user thereof to search for and use supplemental tools for him/her to insert/remove the ground anchor into/from the ground.

Another advantage of the ground anchor of the invention is that it is not structurally complicated.

Another advantage of the ground anchor of the invention is that it is not expensive to manufacture.

Another advantage of the ground anchor of the invention is that it, for reasons of convenience, positively anchors to the ground a bottom portion of another type of implement that is supported by the ground to prevent displacement of the implement and benefits from advantages similar to those described immediately above in connection with the ladder.

Objects, features, and other advantages of the ground anchor of the invention are readily appreciated as the ground anchor becomes more understood while the subsequent detailed description of embodiments of the ground anchor is read taken in conjunction with the accompanying drawing thereof.

### BRIEF DESCRIPTION OF EACH FIGURE OF DRAWING

FIG. 1 is an environmental perspective view of a first embodiment of an anchor for positively anchoring an outdoor implement in place to ground of the invention showing a pair of the ground anchor employed with an extension ladder and disposed in an “operative” state.

FIG. 2 is an isolated environmental side view of the first embodiment of the ground anchor of the invention illustrated in FIG. 1 and showing the pair of the ground anchor employed with particularly a bottom portion of a rail of the ladder and disposed in an “extended” state.

FIG. 3 is an isolated environmental side view of the first embodiment of the ground anchor of the invention illustrated in FIG. 1 and showing a pair of the ground anchor employed with particularly a bottom portion of a rail of the ladder and disposed in a “retracted” state and another pair of the ground anchor employed with particularly a bottom portion of the other rail of the ladder and disposed in the “extended” state.

FIG. 4 is a side view of the first embodiment of the ground anchor of the invention illustrated in FIG. 1 and showing the ground anchor disposed in an “extending/retracting” state (“phantom line” aspect) and the “extended” state (“solid line” aspect).

FIG. 5 is an environmental perspective view of the first embodiment of the ground anchor of the invention illustrated in FIG. 1 and showing two pairs of the ground anchor employed with respective opposed sets of rails of a step ladder and disposed in the “extended” state and respective various degrees of pivot and/or rotation relative to the ground and ladder.

FIG. 6 is an environmental perspective view of a second embodiment of the ground anchor of the invention showing the ground anchor employed with a hose-reel assembly and disposed in the “operative” state.

FIG. 7 is an environmental side view of the second embodiment of the ground anchor of the invention illustrated in FIG. 6 and showing one of the ground anchor employed with a front end of the hose-reel assembly and disposed in the “extending/retracting” state (“phantom line” aspect) and the “extended” state (“solid line” aspect) and another of the ground anchor employed with a rear end of the assembly and disposed in the “extended” state.

FIG. 8 is a perspective view of the second embodiment of the ground anchor of the invention illustrated in FIG. 6 and showing the ground anchor disposed in the “extended” state.

FIG. 9 is an exploded perspective view of a third embodiment of the ground anchor of the invention showing the ground anchor disposed in the “extended” state.

FIG. 10 is a perspective view of the third embodiment of the ground anchor of the invention illustrated in FIG. 9 and showing the ground anchor disposed in the “extended” state.

### DETAILED DESCRIPTION OF EMBODIMENTS OF INVENTION

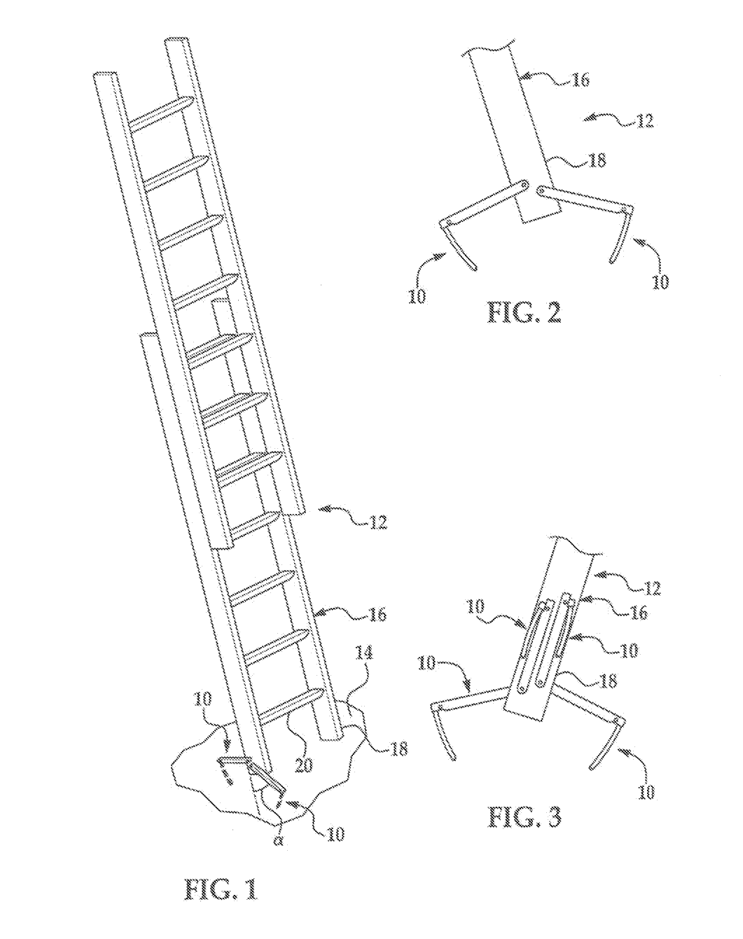

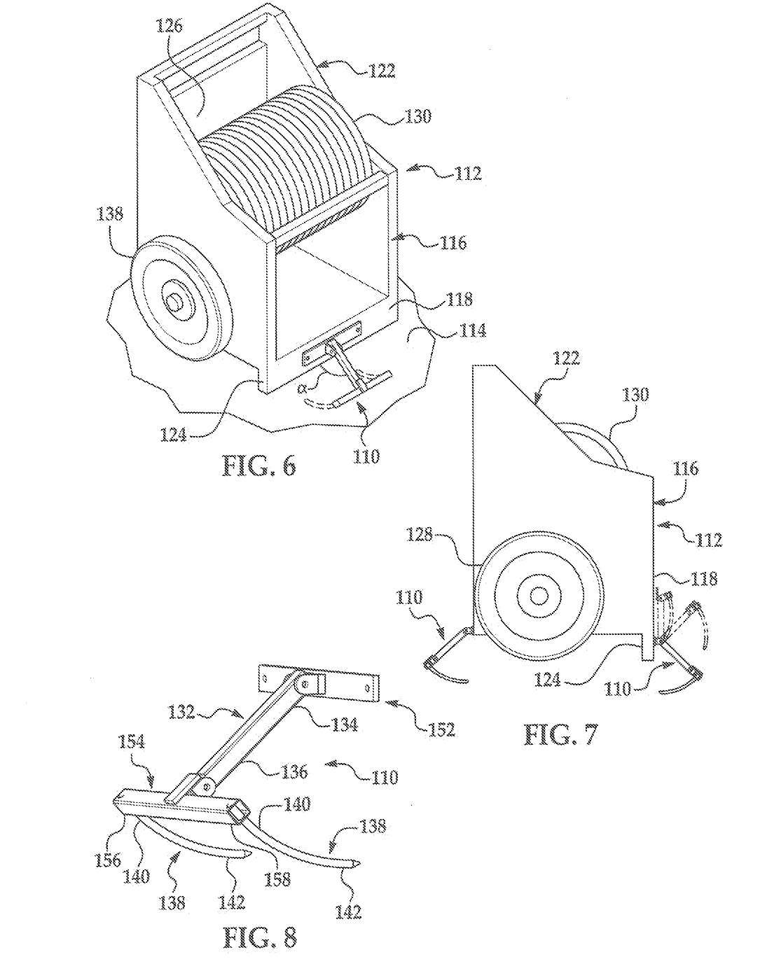

Referring to the figures, throughout which like numerals represent like structure, three embodiments of an anchor for positively anchoring an outdoor implement in place to ground of the invention are generally indicated respectively at 10, 110, and 210. The ground anchor 10, 110, 210 described below and shown in the figures is designed to be employed with especially an implement, generally indicated at 12, 112, that is typically used outdoors on residential or commercial property. However, it should be appreciated by those having ordinary skill in the related art that the ground anchor 10, 110, 210 can be employed with an implement 12, 112 that is used suitably indoors and on any suitable property. Also, the ground anchor 10, 110, 210 is described below and shown in FIGS. 1 through 3 employed in connection with an extension ladder 12, FIG. 5 employed in connection with a step ladder 12, and FIGS. 6 and 7 employed in connection with a hose-reel assembly 112. However, it should be so appreciated also that the implement 12, 112 may be any suitable implement 12, 112. It should be so appreciated also that each of the three embodiments of the ground anchor 10, 110, 210 can be employed with a particular suitable implement 12, 112. And, in the description of the ground anchor 10, 110, 210 that follows, “ground” 14, 114 (shown in FIGS. 1 and 6) generically refers to non-solid surfaces—such as (but not limited to) grass, snow, or soil. In this regard, it should be so appreciated also that “ground” can refer to any suitable non-solid surface. Accordingly, it should be so appreciated also that the invention is in no way limited by the context of the embodiments of the ground anchor 10, 110, 210 disclosed herein.

Referring now particularly to FIGS. 1 through 3 and 5, it should be appreciated by those having ordinary skill in the related art that each of the extension and step ladders 12 is standard with respect to its kind. In this way, the ladder 12 includes at least one rail, generally indicated at 16 (which defines a bottom portion 18 of the rail 16), and at least one rung. More specifically, the ladder 12 includes two pairs of opposed rails 16 and a plurality of rungs, including a bottom rung 20, each of which is attached to and extends between corresponding rails 16.

Referring now particularly to FIGS. 6 and 7, in a like manner, it should be so appreciated also that the hose-reel assembly 112 is standard with respect to its kind as well. In this way, the hose-reel assembly 112 includes a frame, generally indicated at 122, defining a front end, generally indicated at 116, hollow interior 126 (shown only in FIG. 6), and at least one pair of legs 124 (only one leg 124 shown in each of FIGS. 6 and 7) of the frame 122. In turn, the front end 116 defines a bottom portion 118 of the front end 116. The hose-reel assembly 112 includes also a pair of opposed wheels 128 (only one of which is shown) upon which the frame 122 is rotationally supported. The figures show a hose 130 reelingly supported within the hollow interior of the frame 122 as well.

It should be appreciated by those having ordinary skill in the related art that each of the extension and step ladders 12 can have any suitable shape, size, and structure and any part of the ladder 12 can have any suitable structural relationship with any other part of the ladder 12. It should be so appreciated also that the ladder 12 can be any suitable type of ladder, such as a straight ladder. It should be so appreciated also that the hose-reel assembly 112 can have any suitable shape, size, and structure and any part of the hose-reel assembly 112 can have any suitable structural relationship with any other part of the hose-reel assembly 112. It should be so appreciated also that the hose-reel assembly 112 can be any suitable type of hose-reel assembly 112.

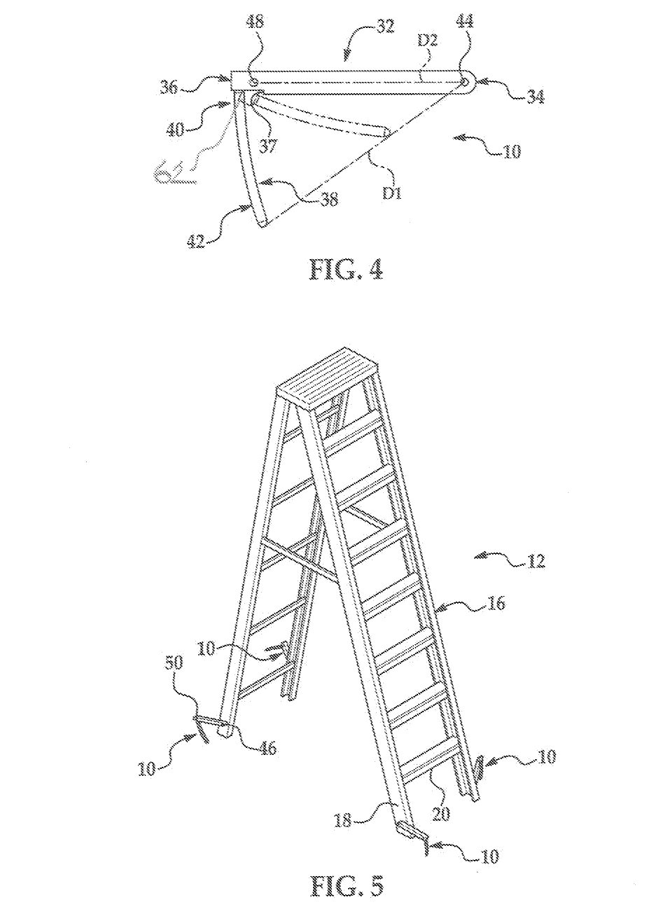

With reference now to the first embodiment illustrated in FIGS. 1 through 5 (in particular, FIG. 4) and in the most basic form of this embodiment, the ground anchor 10 comprises an arm, generally indicated at 32, defining opposed first and second ends (generally indicated at 34, 36, respectively) of the arm 32. The first end 34 is pivotably connected to the ladder 12 such that the arm 32 is pivotable with respect to the ladder 12. A spike, generally indicated at 38, defines opposed first and second ends (generally indicated at 40, 42, respectively) of the spike 38 and is arcuate such that the spike 38 is operatively concave with respect to the arm 32. The first end 40 of the spike 38 is pivotably connected to the second end 36 of the arm 32 such that the spike 38 is rotatable about the second end 36 of the arm 32. The second end 42 of the spike 38 is adapted to be manually imbedded into the ground 14 at substantially a right or an acute angle with respect to the arm 32 to, thereby, positively anchor the ladder 12 in place to the ground 14 with pretension.

More specifically, the first end 34 of the arm 32 defines a hole 44 of the first end 34 adapted to matingly receive a connector 46 (shown in FIG. 5) for pivotably connecting the first end 34 of the arm 32 to the ladder 12 such that the arm 32 is continuously pivotable with respect to the ladder and rotatable about the hole 44. The hole 44 defines a first pivot point 44. The arm 32 is adapted to so operatively pivot and rotate from the ground 14, away from the ground 14, and to at least the ladder 12. As shown in FIG. 3, the arm 32 can be substantially aligned with the rail 16 of the ladder 12. [Those having ordinary skill in the related art should appreciate that the arm 32 can be designed to so pivot and rotate about 360° (only, of course, when the arm 32 has sufficient clearance for the arm 32 to do so).]

The second end 36 of the arm 32 defines a hole 48 of the second end 36 adapted to matingly receive a connector 50 (shown in FIG. 5). A corresponding first hole (not shown) is defined in a pivot piece 62 of the spike 38 and through which the connector 50 is matingly inserted. In this way, the second end 36 of the arm 32 is pivotably connected to the pivot piece 62 such that the spike 38 is continuously rotatable about the second end 36 of the arm 32—that is, the hole 48. The hole 48 defines a second pivot point 48. The spike 38 is adapted to so rotate clockwise (as viewed in FIG. 4) from at least the arm 32 for at least substantially 90°. In the embodiment shown in FIGS. 1 through 5, the spike 38 is adapted to so rotate no greater than substantially 90° [although it should be appreciated by those having ordinary skill in the related art that the spike 38 can be designed to so pivot and rotate about 360° (only, of course, when the spike 38 has sufficient clearance for the spike 38 to do so)]. As shown in FIG. 3, the spike 38 can be substantially aligned with the arm 32 and rail 16 of the ladder 12 such that the ground anchor 10 is disposed out of the way of functionality of the ladder 12.

As shown in FIG. 4, the second end 36 of the arm 32 defines also a combination of a notch and interior space 37 of the second end 36 adapted to receive the pivot piece 62 and permit the spike 38, in general, and pivot piece 62, in particular, to be displaced substantially linearly toward the first end 34 of the arm 32 as the pivot piece 62 pivots counterclockwise about the hole 48 and away from the first end 34 of the arm 32 as the pivot piece 62 pivots clockwise about the hole 48. The notch 37 defines a substantially rectangular longitudinal cross-section of the notch 37. In an “extending/retracting” state (“phantom line” aspect) of the spike 38, the pivot piece 62 is disposed at least partially exterior the arm 32. In contrast, in an “extended” state (“solid line” aspect) of the spike 38, the pivot piece 62 is disposed substantially interior the arm 32.

In the embodiment shown, the arm 32 defines a substantially rectangular longitudinal cross-section of the arm 32. A tip of the first end 34 is arcuate, and a tip of the second end 36 is substantially linear. The arm 32 is substantially longer and wider than the spike 38.

In the embodiment shown, the spike 38 defines a substantially circular transverse cross-section of the spike 38. The first end 40 includes the pivot piece 62, which is substantially block-like (except for a rounded end of the pivot piece 62) and bulkier than a remainder of the spike 38 and extends through the notch 37 and into the interior space 37 of the arm 32. A corresponding second hole (not shown) is defined in the pivot piece 62 and through which the first end 40 is matingly inserted. A tip of the first end 40 is substantially linear, and a tip of the second end 42 is tacked.

As shown in FIG. 4, the first pivot point 44 to the tip of the second end 42 of the spike 38 defines a first distance “D1.” However, when the spike 38 is imbedded into the ground 14, the spike 38 is drawn such that the first pivot point 44 to the tip of the first end 40 of the spike 38 defines a second distance “D2” that is about a quarter of an inch shorter than the first distance “D1” to, thereby, define the pretensioning. In an embodiment, each of the first distance “D1” and second distance “D2” ranges from substantially 6¾ inches to substantially 7¼ inches. In particular, the first distance “D1” is substantially seven inches, and the second distance “D2” is substantially 6¾ inches. Also, the radius of curvature of the spike 38 is substantially seven inches.

The second end 42 of the spike 38 is adapted to be manually imbedded into the ground 14 such that the arm 32 forms an angle “α” (FIG. 1) of between about 25° and about 35° with respect to an imaginary line that extends through the first pivot point 44 and is substantially parallel with the rail 16 to, thereby, positively anchor the ladder 12 in place to the ground 14 with pretension. In particular, such angle “α” is substantially 30°.

The arm 32 is adapted to move in an imaginary plane that is substantially identical to that in which the spike 38 is adapted to move. That is to say, all motion of the ground anchor 10 takes place in this plane. Despite such adaptability of the ground anchor 10 to so move, structural integrity of the ground anchor 10 permits continued positive anchoring of the ladder 12 in place to the ground 14 with pretension once the ladder 12 is so anchored.

Operatively, the first end 34 of the arm 32 is pivotably connected to specifically a “contact” surface of a side of the bottom portion 18 of the rail 16 such that the arm 32 is pivotable with respect to the ladder 12. For added grounding, as shown in each of FIGS. 1 through 3, a pair of ground anchors 10 can be mounted back-to-back with respect to each other to one rail 16 or each of two rails 16 of an at least partially raised extension ladder 12. Alternatively or in addition, a ground anchor 10 can be mounted to the bottom rung 20 (not shown). As shown in FIG. 5, in a preferred use of the ground anchor 10, a ground anchor 10 is mounted to each of the four rails 16 (and/or bottom rungs 20) of the ladder 12 such that there are opposed pairs of back-to-back ground anchors 10. As shown in FIG. 1, also in a preferred use of the ground anchor 10, the first end 40 of the spike 38 is disposed at a substantially right angle with respect to the arm 32, and the second end 42 of the spike 38 is disposed at a substantially acute angle with respect to the arm 32 when the spike 38 is imbedded into the ground 14.

It should be appreciated by those having ordinary skill in the related art that each of the arm 32 and spike 38, in general, and respective first ends 34, 40, second ends 36, 42, and pivot piece 62, in particular, can have any suitable shape, size, and structure. It should be so appreciated also that the arm 32 and spike 38 can have any suitable structural relationship with each other and the ladder 12. It should be so appreciated also that the pivot piece 62 and remainder of the spike 38 can have any suitable structural relationship with each other. It should be so appreciated also that the first end 34 of the arm 32 can be pivotably connected to the ladder 12, the second end 36 of the arm 32 can be pivotably connected to the first end 40 of the spike 38, and the spike 38 can be imbedded into the ground 14 in any suitable manner. It should be so appreciated also that the spike 38, in general, and pivot piece 62, in particular, can be displaced substantially linearly toward or away from the first end 34 of the arm 32 any suitable distance. It should be so appreciated also that the arm 32 and spike 38 can pivot and rotate any suitable number of degrees. It should be so appreciated also that each of the first distance “D1” and second distance “D2” can define any suitable distance. It should be so appreciated also that the spike 38 can define any suitable radius of curvature of the spike 38. It should be so appreciated also that the second end 42 of the spike 38 can be manually imbedded into the ground 14 at any suitable angle with respect to the imaginary plane that is substantially normal to the ground 14. It should be so appreciated also that the ground anchor 10 can be mounted to any suitable “contact” surface of the ladder 12. It should be so appreciated also that any suitable number of ground anchors 10 can be mounted to the ladder 12.

With reference to the second embodiment illustrated in FIGS. 6 through 8 (in particular, FIG. 8) [where similar or like parts of the ground anchor 110 have similar or like reference numerals with respect to the ground anchor 10 increased by one hundred (100)] and in a most basic form of the second embodiment, the ground anchor 110 comprises a brace, generally indicated at 152, attached to the hose-reel assembly 112 and a support, generally indicated at 154, defining opposed first and second ends 156, 158 of the support 154. An arm, generally indicated at 132, extends between the brace 152 and support 154 and defines opposed first and second ends 134, 136 of the arm 132. The first end 134 of the arm is pivotably connected to the brace 152 and, thus, hose-reel assembly 112 such that the arm 132 is rotatable about the brace 152, and the second end 136 of the arm 132 is attached to the support 154. Each of at least a pair of opposed spikes, generally indicated at 138, defines opposed first and second ends 140, 142 of the spike 138 and is arcuate such that the spike 138 is operatively concave with respect to the arm 132. The first ends 140 of the corresponding spikes 138 are attached respectively to the first and second ends 156, 158 of the support 154 such that the spikes 138 are rotatable about the brace 152 via the arm 132. The second ends 142 of the corresponding spikes 138 are adapted to be manually imbedded into the ground 114 at substantially a right or an acute angle with respect to the arm 132 to, thereby, positively anchor the hose-reel assembly 112 in place to the ground 114 with pretension.

[It should be appreciated by those having ordinary skill in the related art that, although the spikes 138 of the ground anchor 110 are not described herein or shown in the figures as being adapted to be displaced substantially linearly relative to the corresponding ends 156, 158 of the support 154 as the spike 138 rotates about the brace 152 via the arm 132, an embodiment of the ground anchor 110 permits such displacement with relevant structure corresponding to that of the ground anchors 10, 210 described herein and shown in the figures. It should be so appreciated also that, in turn, the second end 142 of each of the spikes 138 to the corresponding end 156, 158 of the support 154 defines a first distance and, when the spike 138 is imbedded into the ground 114, the spike 138 is drawn such that the first end 140 of the spike 138 to the corresponding end 156, 158 of the support 154 defines a second distance that is shorter than the first distance to, thereby, define the pretensioning.]

In an embodiment of the ground anchor 110, a length of the ants 132 is substantially perpendicular to a length of each of the brace 152 and support 154, and the length of the brace 152 is substantially parallel with the length of the support 154. The spikes 138 are substantially uniform and disposed substantially parallel and mirror-like with respect to each other, and corresponding imaginary vertical planes defined by the spikes 138 are substantially parallel with the length of the arm 132 and perpendicular to the length of each of the brace 152 and support 154.

The arm 132, spikes 138, and support 154 are continuously pivotable and rotatable with respect to the brace 152. The arm 132, spikes 138, and support 154 are adapted to so operatively pivot and rotate counter-clockwise (as viewed from the right side in FIG. 7) from the ground 114, away from the ground 114, and to abutting relationship with the hose-reel assembly 112. As shown in the figure, the arm 132 and support 154 can be substantially aligned with and the spikes 138 can be abutted against the front end 116 of the hose-reel assembly 112 such that the ground anchor 110 is disposed out of the way of functionality of the hose-reel assembly 112. [Those having ordinary skill in the related art should appreciate that the arm 132, spikes 138, and support 154 can be designed to so pivot and rotate about 180° (only, of course, when the arm 132, spikes 138, and support 154 have sufficient clearance for the arm 132, spikes 138, and support 154 to do so).]

In the embodiment shown, each of the arm 132, brace 152, and support 154 defines a substantially rectangular longitudinal cross-section of the arm 132, brace 152, and support 154. The arm 132 is substantially longer and wider than the spikes 138 and substantially longer than each of the brace 152 and support 154.

In the embodiment shown, each of the spikes 138 defines a substantially circular transverse cross-section of the spike 138. A tip of each of the second ends 142 is tacked.

As with the spike 38 of the ground anchor 10, the spikes 138 of the ground anchor 110 can be pivotable (here, relative to the corresponding first and second ends 156, 158 of the support 154). In such an embodiment, the first pivot point to the tip of the second end 142 of each of the spikes 138 defines a first distance. However, when the spike 138 is imbedded into the ground, the spike 138 is drawn such that the first pivot point to the tip of the first end 140 of the spike 138 defines a second distance that is about a quarter of an inch shorter than the first distance to, thereby, define the pretensioning. In an embodiment, each of the first and second distances ranges from substantially 6¾ inches to substantially 7¼ inches. In particular, the first distance is substantially seven inches, and the second distance is substantially 6¾ inches. Also, the radius of curvature of the spike 138 is substantially seven inches.

The second end 142 of each of the spikes 138 is adapted to be manually imbedded into the ground 114 such that the arm 132 forms an angle “α” (FIG. 6) of between about 25° and about 35° with respect to an imaginary line that extends through the first pivot point and is substantially parallel with the front end 116 of the hose-reel assembly 112 to, thereby, positively anchor the hose-reel assembly 112 in place to the ground 114 with pretension. In particular, such angle “α” is substantially 30°.

The arm 132 is adapted to move in an imaginary plane that is substantially parallel to that in which each of the spikes 138 is adapted to move. That is to say, all motion of the ground anchor 110 takes place in an imaginary plane a thickness of which is defined by the length of the support 154. Despite such adaptability of the ground anchor 110 to so move, structural integrity of the ground anchor 110 permits continued positive anchoring of the hose-reel assembly 112 in place to the ground 114 with pretension once the hose-reel assembly 112 is so anchored.

Operatively, the first end 134 of the arm 132 is pivotably connected via the brace 152 to specifically a “bracing” surface of the bottom portion 118 of the front end 116 of the hose-reel assembly 112 such that the arm 132 is pivotable with respect to the hose-reel assembly 112. For added grounding, as shown in FIG. 7, a pair of ground anchors 110 can be mounded respectively to the front end 116 and a rear end of the hose-reel assembly 112. In a preferred use of the ground anchor 110 with a ladder, a ground anchor 110 is mounted to each of the rails and/or bottom rungs of the ladder such that there are opposed pairs of back-to-back ground anchors 110. Also in a preferred use of the ground anchor 110, the first ends 140 of the corresponding spikes 138 are disposed at a substantially right angle with respect to the arm 132, and the second ends 142 of the corresponding spikes 138 are disposed at a substantially acute angle with respect to the arm 132 when the spikes 138 are imbedded into the ground.

It should be appreciated by those having ordinary skill in the related art that each of the arm 132, spikes 138, brace 152, and support 154, in general, and respective first ends 134, 140, 156 and second ends 136, 142, 158, in particular, can have any suitable shape, size, and structure. It should be so appreciated also that the arm 132, spikes 138, brace 152, and support 154 can have any suitable structural relationship with each other and the hose-reel assembly 112. It should be so appreciated also that the brace 152 can be mounted to the hose-reel assembly 112, the first end 134 of the arm 132 can be pivotably connected to the brace 152, the second end 136 of the arm 132 can be mounted to the support 154, the first ends 140 of the corresponding spikes 138 can be mounted respectively to the first and second ends 156, 158 of the support 154, and the spikes 138 can be imbedded into the ground 114 in any suitable manner. It should be so appreciated also that the arm 132, spikes 138, and support 154 can pivot and rotate any suitable number of degrees. It should be so appreciated also that each of the first and second distances can define any suitable distance. It should be so appreciated also that each of the spikes 138 can define any suitable radius of curvature of the spike 138. It should be so appreciated also that the second end 142 of each of the spikes 138 can be manually imbedded into the ground 114 at any suitable angle with respect to the imaginary plane that is substantially normal to the ground 114. It should be so appreciated also that the ground anchor 110 can be mounted to any suitable “bracing” surface of the hose-reel assembly 112. It should be so appreciated also that any suitable number of ground anchors 110 can be mounted to the hose-reel assembly 112.

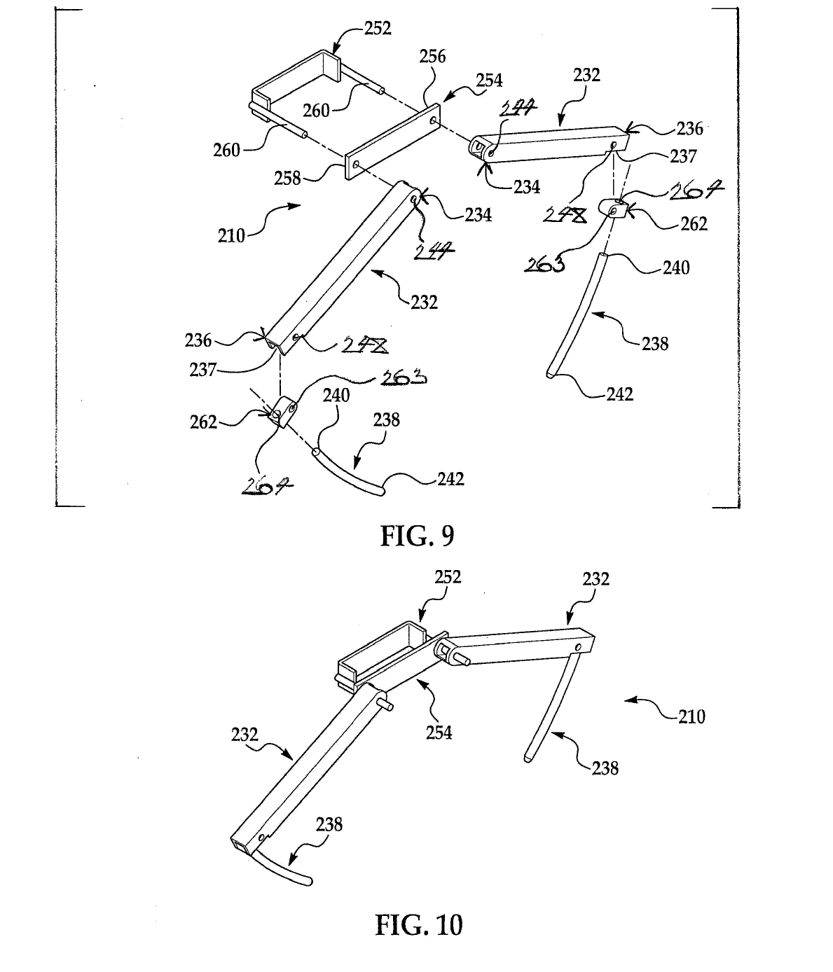

With reference to the third embodiment illustrated in FIGS. 9 and 10 [where similar or like parts of the ground anchor 210 have similar or like reference numerals with respect to the ground anchor 10, 110 increased respectively by two hundred (200) and one hundred (100)] and in a most basic form of the embodiment, the ground anchor 210 comprises a brace, generally indicated at 252, attached to the implement (not shown) and a support, generally indicated at 254, defining opposed first and second ends (generally indicated at 256, 258, respectively) of the support 254 and attached to the brace 252. Each of at least a pair of arms, generally indicated at 232, defines opposed first and second ends (generally indicated at 234, 236, respectively) of the arm 232. The first ends 234 of the corresponding arms 232 are pivotably connected respectively to the first and second ends 256, 258 of the support 254 and, thus, implement such that the arms 232 are rotatable about the support 254 and, thereby, pivotable with respect to the implement. Each of at least a pair of opposed spikes, generally indicated at 238, defines opposed first and second ends (generally indicated at 240, 242, respectively) of the spike 238 and is arcuate such that the spike 238 is operatively concave with respect to the corresponding arm 232. The first ends 240 of the corresponding spikes 238 are pivotably connected respectively to the second ends 236 of the corresponding arms 232 such that the spikes 238 are respectively rotatable about the second ends 236 of the arms 232 and support 254 via the arm 232. The second ends 242 of the corresponding spikes 238 are adapted to be manually imbedded into the ground at substantially a right or an acute angle with respect to the corresponding arms 232 to, thereby, positively anchor the implement in place to the ground with pretension.

More specifically, a pair of opposed shafts 260 (which are disposed substantially perpendicular with respect to a length of the brace 252) extend from opposite ends of the brace 252, respectively through the first and second ends 256, 258 of the support 254, and respectively into the first ends 234 of the corresponding arms. The shafts 260 support the brace 252, support 254, and arms 232 to each other.

To that end, the first end 234 of each of the arms 232 defines a hole 244 of the first end 234 adapted to matingly receive the corresponding shall 260 for pivotably connecting the first end 234 of the arm 232 to the implement such that the arm 232 is continuously pivotable with respect to the implement and rotatable about the hole 244. The hole 244 defines a first pivot point 244.

The second end 236 of each of the arms 232 defines a hole 248 of the second end 236 adapted to matingly receive a connector (not shown). A corresponding first hole 263 is defined in a pivot piece, generally indicated at 262, of the corresponding spike 238 and through which the connector is matingly inserted. In this way, the second end 236 of the arm 232 is pivotably connected to the pivot piece 262 such that the spike 238 is continuously rotatable about the second end 236 of the arm 232—that is, the hole 248. The hole 248 defines a second pivot point 248.

As shown in FIG. 9, the second end 236 of the arm 232 defines also a combination of a notch and interior space 237 of the second end 236 adapted to receive the pivot piece 262 and permit the spike 238, in general, and pivot piece 262, in particular, to be displaced substantially linearly (when viewing the left side of the figure) toward the first end 234 of the arm 232 as the pivot piece 262 pivots counterclockwise about the hole 248 and away from the first end 234 of the arm 232 as the pivot piece 262 pivots clockwise about the hole 248. The notch 237 defines a substantially rectangular longitudinal cross-section of the notch 237.

The arms 232 are adapted to move toward and away from each other in an imaginary plane that is substantially identical to that in which the spikes 238 are adapted to move. The spikes 238 are substantially uniform and disposed substantially mirror-like with respect to each other and adapted to move toward and away from each other. An imaginary vertical plane is defined by the support 254, arms 232, and spikes 238.

The arms 232 and spikes 238 are continuously pivotable and rotatable with respect to the brace 252 and support 254. The arms 232 and spikes 238 are adapted to so operatively pivot and rotate clockwise (left)/counter-clockwise (right) (as viewed in FIG. 10) from the ground, away from the ground, and to abutting relationship of the anus 232 with each other. The arms 232 and spikes 238 can be substantially aligned with and the brace 252 can be abutted against the implement such that the ground anchor 216 is disposed out of the way of functionality of the implement. [Those having ordinary skill in the related art should appreciate that the arms 232 can be designed to so pivot and rotate about 360° (only, of course, when the arms 232 have sufficient clearance for the arms 232 to do so).] In the embodiment shown in FIGS. 9 and 10, the spikes 238 are adapted to so pivot and rotate with respect to the corresponding arms 232 no greater than substantially 90° [although it should be appreciated by those having ordinary skill in the related art that the spikes 238 can be designed to so pivot and rotate about 360° (only, of course, when the spikes 238 have sufficient clearance for the spikes 238 to do so)].

In the embodiment shown, each of the arms 232, brace 252, and support 254 defines a substantially rectangular longitudinal cross-section of the arm 232, brace 252, and support 254. Each of the anus 232 are substantially longer and wider than the spikes 238 and substantially longer than each of the brace 252 and support 254.

In the embodiment shown, each of the spikes 238 defines a substantially circular transverse cross-section of the spike 238. The first end 240 includes the pivot piece 262, which is substantially block-like (except for a rounded end of the pivot piece 262) and bulkier than a remainder of the spike 238 and extends through the notch 237 and into the interior space 237 of the arm 232. A corresponding second hole 264 is defined in the pivot piece 262 and through which the first end 240 is matingly inserted. A tip of each of the second ends 242 is tacked.

The first pivot point 244 to the tip of the second end 242 of each of the spikes 238 defines a first distance “D1.” However, when the spike 238 is imbedded into the ground, the spike 238 is drawn such that the first pivot point 244 to the tip of the first end 240 of the spike 238 defines a second distance “D2” that is about a quarter of an inch shorter than the first distance “D1” to, thereby, define the pretensioning. In an embodiment, each of the first distance “D1” and second distance “D2” ranges from substantially 6¾ inches to substantially 7¼ inches. In particular, the first distance “D1” is substantially seven inches, and the second distance “D2” is substantially 6¾ inches. Also, the radius of curvature of the spike 238 is substantially seven inches.

The second end 242 of each of the spikes 238 is adapted to be manually imbedded into the ground such that each of the arms 232 forms an angle “α” of between about 25° and about 35° with respect to an imaginary line that extends through the corresponding first pivot point 244 and is substantially parallel with the rail to, thereby, positively anchor the implement in place to the ground with pretension. In particular, such angle “α” is substantially 30°.

All motion of the ground anchor 210 takes place in the imaginary plane. Despite such adaptability of the ground anchor 210 to so move, structural integrity of the ground anchor 210 permits continued positive anchoring of the implement in place to the ground with pretension once the implement is so anchored.

Operatively, the first ends 234 of the corresponding arms 232 are pivotably connected via the brace 252 to specifically a “bracing” surface of the bottom portion of the implement such that the arms 232 are pivotable with respect to the implement. For added grounding, a plurality of ground anchors 210 can be mounded to the implement. In a preferred use of the ground anchor 210 with a ladder, a ground anchor 210 is mounted to each of the rails and/or bottom rungs of the ladder such that there are opposed pairs of back-to-back ground anchors 210. Also in a preferred use of the ground anchor 210, the first ends 240 of the corresponding spikes 238 are disposed at a substantially right angle relative to the respective arms 232, and the second ends 242 of the corresponding spikes 138 are disposed at a substantially acute angle relative to the respective arms 232 when the spikes 138 are imbedded info the ground.

It should be appreciated by those having ordinary skill in the related art that each of the arms 232, spikes 238, brace 252, and support 254, in general, and respective first ends 234, 240, 256, second ends 236, 242, 258, and pivot pieces 262, in particular, can have any suitable shape, size, and structure. It should be so appreciated also that the anus 232, spikes 238, brace 252, and support 254 can have any suitable structural relationship with each other and the implement. It should be so appreciated also that the pivot pieces 262 and remainder of the corresponding spikes 238 can have any suitable structural relationship with each other. It should be so appreciated also that the brace 252 can be mounted to the implement, the support 254 can be mounted to the brace 252, the first ends 234 of the corresponding arms 232 can be pivotably connected to the support 254, the first ends 240 of the corresponding spikes 238 can be pivotably connected respectively to the second ends 236 of the corresponding arms 232, and the spikes 238 can be imbedded into the ground in any suitable manner. It should be so appreciated also that the spikes 238, in general, and corresponding pivot pieces 262, in particular, can be displaced substantially linearly toward or away from the respective first ends 34 of the corresponding arms 232 any suitable distance. It should be so appreciated also that the arms 232 and spikes 238 can pivot and rotate any suitable number of degrees. It should be so appreciated also that each of the first distance “D1” and second distance “D2” can define any suitable distance. It should be so appreciated also that each of the spikes 238 can define any suitable radius of curvature of the spike 238. It should be so appreciated also that the second end 242 of each of the spikes 238 can be manually imbedded into the ground at any suitable angle with respect to the imaginary plane that is substantially normal to the ground. It should be so appreciated also that the ground anchor 210 can be mounted to any suitable “bracing” surface of the implement. It should be so appreciated also that my suitable number of ground anchors 210 can be mounted to the implement.

In operation of the ground anchor 10, 110, 210, the ground anchor 10, 110, 210 is mounted to the bottom portion 18, 118 of the implement 12, 112. Then, structural elements of the ground anchor 10, 110, 210 are pivoted and rotated in such a way that the spike(s) 38, 138, 238 can be imbedded into the ground 14, 114. Then, the second end(s) 42, 142, 242 of the spike(s) 38, 138, 238 is/are manually imbedded into the ground 14, 114 to, thereby, positively anchor the implement 12, 112 in place to the ground 14, 114 with pretension. At least one more ground anchor 10, 110, 210 can be so mounted, pivoted and rotated, and imbedded for additional grounding of the implement 12, 112. In a preferred use of the ground anchor 10, 110, 210 with a ladder 12, a ground anchor 10, 110, 210 is mounted to each of the rails and/or bottom rungs 20 of the ladder 12. Also in a preferred use of the ground anchor 10, 110, 210, the first end 40, 140, 240 of each spike 38, 138, 238 is disposed at a substantially right angle with respect to the corresponding arm 32, 132, 232, and the second end 42, 142, 242 of the spike 38, 138, 238 is disposed at a substantially acute angle with respect to the arm 32, 132, 232 when the spike 38, 138, 238 is imbedded into the ground.

It should be appreciated by those having ordinary skill in the related art that the ground anchor 10, 110, 210, in general, and each structural element of the ground anchor 10, 110, 210, in particular, can be made of any suitable material—such as steel, metal, and/or plastic. It should be so appreciated also that the ground anchor 10, 110, 210, in general, and each structural element of the ground anchor 10, 110, 210, in particular, can be made by any suitable method.

The ground anchor 10, 110, 210, for reasons of safety, positively anchors to the ground 14 a bottom portion 18 of a ladder 12 that is supported by the ground 14 and a side of a structure to prevent displacement of the ladder 12. Also, the ground anchor 10, 110, 210 effectively prevents the displacement of the ladder 12 away from the structure as well as effectively stabilizes the ladder 12 from slipping side to side and coming off the ground 14. Furthermore, the ground anchor 10, 110, 210 can be provided on one rail 16 or more rails 16 of the ladder 12 without the ground anchor 10, 110, 210 interfering with any rung 20 of the ladder 20. In addition, the ground anchor 10, 110, 210 can be provided on a bottom rung 20 of the ladder 12 without the ground anchor 10, 110, 210 interfering with any rail 16 of the ladder 12. Moreover, the ground anchor 10, 110, 210 can be easily and quickly manually embedded far enough into the ground 14 to provide adequate support to the ladder 12 during use of the ladder 12 on the ground 14 when the ground 14 is uneven or unstable while still allowing easy and quick manual removal of the ground anchor 10, 110, 210 from the ground 14.

Also, the ground anchor 10, 110, 210 does not interfere with or cause damage to the ladder 12 or cause damage to the ground 14 while the ground anchor 10, 110, 210 is being embedded into or removed from the ground 14. Furthermore, the ground anchor 10, 110, 210 does not require a user of the ground anchor 10, 110, 210 to search for and use supplemental tools for him/her to insert/remove the ground anchor 10, 110, 210 into/from the ground 14. In addition, the ground anchor 10, 110, 210 is not structurally complicated or expensive to manufacture. Moreover, the ground anchor 10, 110, 210, for reasons of convenience, positively anchors to the ground 114 a bottom portion 118 of another type of implement 112 that is supported by the ground 114 to prevent displacement of the implement 112 and benefits from advantages similar to those described immediately above in connection with the ladder 12.

The ground anchor 10, 110, 210 has been described above in an illustrative manner. It is to be understood that the terminology that has been used is intended to be in the nature of words of description rather than of limitation. Many modifications and variations of the ground anchor 10, 110, 210 are possible in light of the above teachings. Therefore, within the scope of the appended claims, the ground anchor 10, 110, 210 may be practiced other than as specifically described above.

1. A ground anchor for positively anchoring an outdoor implement in place to the ground, said ground anchor comprising:
an arm defining opposed first and second ends of said arm, said first end being pivotably and directly connected to the implement such that said arm is pivotable with respect to the implement; and
a spike defining opposed first and second ends of said spike and being arcuate such that said spike is operatively concave with respect to said arm, said first end of said spike being pivotably connected to said second end of said arm such that said spike is rotatable about said second end of said arm and said second end of said spike being adapted to be manually imbedded into the ground at either of a right and an acute angle with respect to said arm to, thereby, positively anchor the implement in place to the ground with pretension.

2. A ground anchor as set forth in claim 1, wherein said spike is displaced substantially linearly relative to said first end of said arm as said spike rotates about said second end of said arm.

3. A ground anchor as set forth in claim 1, wherein said first end of said arm to said second end of said spike defines a first distance and, when said spike is imbedded into the ground, said spike is drawn such that said first end of said arm to said first end of said spike defines a second distance that is shorter than said first distance to, thereby, define said pretensioning.

4. A ground anchor as set forth in claim 1, wherein said spike defines a radius of curvature of said spike that is equal to seven inches.

5. A ground anchor as set forth in claim 1, wherein said second end of said spike is adapted to be manually imbedded into the ground such that said arm forms an angle of between 25° and 35° with respect to an imaginary line that is substantially parallel with the implement.

6. A ground anchor as set forth in claim 1, wherein the implement includes either of a ladder and hose-reel assembly having at least one contact surface and said first end of said arm is pivotably connected to the contact surface.

7. A ground anchor as set forth in claim 6, wherein the ladder includes either of a bottom rung and rail and said first end of said arm is pivotably connected to the corresponding bottom rung or a bottom portion of the rail.

8. A ground anchor for positively anchoring an outdoor implement in place to the ground, said ground anchor comprising:
a brace attached to the implement;
a support defining opposed first and second ends of said support;
an arm extending between said brace and support and defining opposed first and second ends of said arm, said first end of said arm being pivotably and directly connected to said brace and, thus, the implement such that said arm is rotatable about said brace and said second end of said arm being attached to said support; and
at least a pair of opposed spikes each of which defines opposed first and second ends and is arcuate such that each of said at least a pair of opposed spikes is operatively concave with respect to said arm, said first ends of corresponding said at least a pair of opposed spikes being attached respectively to said first and second ends of said support such that said at least a pair of opposed spikes are rotatable about said brace via said arm and said second ends of corresponding said at least a pair of opposed spikes being adapted to be manually imbedded into the ground at either of a right and an acute angle with respect to said arm to, thereby, positively anchor the implement in place to the ground with pretension.

9. A ground anchor as set forth in claim 8, wherein each of said spikes is displaced substantially linearly relative to corresponding said end of said support as said spike rotates about said brace via said arm.

10. A ground anchor as set forth in claim 8, wherein said second end of each of said spikes to corresponding said end of said support defines a first distance and, when said spike is imbedded into the ground, said spike is drawn such that said first end of said spike to said end of said support defines a second distance that is shorter than said first distance to, thereby, define said pretensioning.

11. A ground anchor as set forth in claim 8, wherein each of said spikes defines a radius of curvature of said spike that is equal to seven inches.

12. A ground anchor as set forth in claim 8, wherein said second end of each of said spikes is adapted to be manually imbedded into the ground such that corresponding said arm forms an angle of between 25° and 35° with respect to an imaginary line that is substantially parallel with the implement.

13. A ground anchor as set forth in claim 8, wherein the implement includes either of a ladder and hose-reel assembly having at least one bracing surface and said brace is attached to the bracing surface.

14. A ground anchor as set forth in claim 13, wherein the ladder includes either of a bottom rung and rail and said brace is attached to the corresponding bottom rung or a bottom portion of the rail.

15. A ground anchor for positively anchoring an outdoor implement in place to the ground, said ground anchor comprising:
a brace attached to the implement;
a support defining opposed first and second ends of said support and attached to said brace;
at least a pair of arms each of which defines opposed first and second ends of said arm, said first ends of corresponding said arms being pivotably and directly connected respectively to said first and second ends of said support and, thus, the implement such that said arms are rotatable about said support and, thereby, pivotable with respect to the implement; and
at least a pair of opposed spikes each of which defines opposed first and second ends of said spike and is arcuate such that said spike is operatively concave with respect to corresponding said arm, said first ends of corresponding said spikes being pivotably connected respectively to said second ends of corresponding said arms such that said spikes are respectively rotatable about said second ends of said arms and support via said arm and said second ends of corresponding said spikes being adapted to be manually imbedded into the ground at either of a right and an acute angle with respect to corresponding said arms to, thereby, positively anchor the implement in place to the ground with pretension.

16. A ground anchor as set forth in claim 15, wherein each of said spikes is displaced substantially linearly relative to said first end of corresponding said arm as said spike rotates about said second end of said arm.

17. A ground anchor as set forth in claim 15, wherein said first end of each of said arms to said second end of corresponding said spike defines a first distance and, when said spike is imbedded into the ground, said spike is drawn such that said first end of said arm to said first end of said spike defines a second distance that is shorter than said first distance to, thereby, define said pretensioning

18. A ground anchor as set forth in claim 15, wherein each of said spikes defines a radius of curvature of said spike that is equal to seven inches.

19. A ground anchor as set forth in claim 15, wherein said second end of each of said spikes is adapted to be manually imbedded into the ground such that corresponding said arm forms an angle of between 25° and 35° with respect to an imaginary line that is substantially parallel with the implement.

20. A ground anchor as set forth in claim 15, wherein the implement includes either of a ladder and hose-reel assembly having at least one bracing surface and said brace is attached to the bracing surface.
